(19) United States
(12) Patent Application Publication
(10) Pub. No.: US 2010/0196552 A1
(43) Pub. Date: Aug. 5, 2010

(54) Method of preparing popped fruit

(76) Inventor: Beau Giannini, Napa, CA (US)

Correspondence Address: LUMEN PATENT FIRM, 350 Cambridge Avenue, Suite 100, PALO ALTO, CA, 94306, US

(21) Appl. No.: 12/583,498

(22) Filed: Aug. 20, 2009

Related U.S. Application Data
(63) Continuation-in-part of application No. 12/322,707, filed on Feb. 4, 2009.

(51) Int. Cl. A23L 1/212; A23B 7/02; A23G 1/54

(52) U.S. Cl. 426/93; 426/640; 426/102; 426/616

(57) ABSTRACT

A reduced-step method of producing puffed fruit pieces is provided. The invention is a two-part drying process, where the fruit is oven baked and then popped. The crispy fruit pieces can be flavored using flavorings. From the novel infusion-free and reduced step process the fruit pieces contain nutrients of their fresh fruit essence, making them a healthful and desirable snack. The method includes drying fruit pieces in a wind oven until a specified moisture-content of the fruit pieces are reached, then storing the fruit pieces in a refrigerated environment. The chilled fruit pieces are flavored, and then dehydrated in a low-pressure dehydration chamber until the fruit pieces change from a first state to a second state, and immediately packaged in a nitrogen-filled hermetically sealed package.

### CROSS-REFERENCE TO RELATED APPLICATIONS

This application is a Continuation In Part of and claims the benefit from U.S. application Ser. No. 12/322,707 filed Feb. 4, 2009 and which are hereby incorporated by reference.

### FIELD OF THE INVENTION

The invention relates generally to food processing. More particularly, the invention relates to a method of rapidly processing fruit, and in particular apple pieces, into a dry and crispy texture without an infusion step.

### BACKGROUND

In recent years the human diet has been trending to a more healthful composition that includes more fruits and vegetables. Nevertheless, many people are reluctant to eat enough healthful foods for reasons that can include convenience, appearance, taste, or texture to name a few. In order to address some of these issues, attempts have been made to provide packaged fruit snacks that are delicious and nutritious. Currently, these snacks require a substantial number of lengthy processing steps that leave the fruit browned from oxidation, where the product is discolored and generally visually unappealing to eat. To overcome this problem, at least one of the steps in the process includes an infusion of a preservative. These preservatives are directed to reduce or eliminate the discoloration and to extend a product shelf life.

A further trend has been for consumers to reduce or eliminate the amount of chemical additives in their food. Processed food, in general is widely known to include many preservatives, artificial flavors, sugars, salts or other chemical additives to extend the shelf life of the product and to make the food tasty. Consumers are looking for alternative healthful foods that are convenient and are within the definition of “organic” according to the USDA. Organic foods are made according to certain production standards. According to these standards, they must be grown without the use of conventional pesticides and artificial fertilizers, free from contamination by human or industrial waste, and processed without ionizing radiation or food additives.

Accordingly, there is a need to develop a method of producing a healthful fruit snack that is nutritious, convenient and appetizing to consumers both young and old. There is a need for a method for producing and packaging these snacks in a rapid manner to provide a product that is not discolored from oxidation and does not require an infusion step to prevent discoloration.

### SUMMARY OF THE INVENTION

The present invention provides method of preparing popped fruit pieces that includes assessing a fruit variety according to current ambient climate, time of year, surface area, skin thickness, moisture content and size, then drying the fruit pieces in a wind oven until a specified moisture-content of the fruit pieces is reached, then storing the fruit pieces in a refrigerated environment. The chilled fruit pieces are then flavored, and then dehydrated in a low-pressure dehydration chamber until the fruit pieces change from a first state to a second state.

According to one aspect of the invention, the wind oven has an air-speed up to 15 meters per second.

In a further aspect, the wind oven is operated in a temperature range from 60-70° C.

In yet another aspect, the wind oven is operated for a time period having a range from 1-8 hours.

According to one aspect of the invention, the specified moisture is a water content expressed in terms of the mass of water per unit mass of a moist the fruit piece having a range of 10-20%.

In another aspect, the storage in the refrigerated environment has a duration in a range of up to one year.

In a further aspect of the invention, the refrigerated environment has a temperature range of 0-8° C.

According to anther aspect of the invention, the flavoring includes coating the surfaces of the fruit pieces with consumable flavoring that can include natural, cinnamon, caramel, hazelnut, dark chocolate, cappuccino, champagne, peach, strawberry, blueberry, cranberry, banana, vanilla, chocolate, green tea, salt, pepper, garlic, cheese, vinegar, barbecue, pepper, sour cream, onion, or chili.

In a further aspect, the duration between the flavoring and placing the fruit pieces in a low-pressure dehydration chamber is in a range of 30 min-5 hours.

In another aspect, the low-pressure dehydration chamber has a pressure range of 0.2-0.08 kPa.

In yet another aspect, the second state is a dry, popped and crisp state.

In a further aspect of the invention, the second state has a moisture level having a range of 5-1%.

In yet another aspect, the fruit pieces are immediately packaged upon the transition from the first state to the second state. Here, the duration between the transition to the second state and the packaging is less than 10 minutes. Further, the packaging can be a hermetically sealed and nitrogen filled container.

In another aspect of the invention, the fruit pieces can include apples, blueberries, strawberries, raspberries, blackberries, oranges, kiwis, peaches, apricots, mangos, bananas, pineapple, pears, goji berries, grapes, raisins, Chilean Myrtle fruit, cherries, tomatoes, lychees, cranberries, papayas or acai berries.

According to one embodiment of the invention, a method of preparing apple chips is provided that includes drying apple pieces in a wind oven until a specified moisture-content of the apple pieces is reached, then storing the apple pieces in a refrigerated environment. The chilled apple pieces are then flavored, and then dehydrated in a low-pressure dehydration chamber until the apple pieces change from a first state to a second state.

According to one aspect of the invention, the wind oven has an air-speed up to 15 meters per second.

In a further aspect, the wind oven is operated in a temperature range from 60-70° C.

In yet another aspect, the wind oven is operated for a time period having a range from 4-7 hours.

According to one aspect of the invention, the specified moisture is a water content expressed in terms of the mass of water per unit mass of a moist the apple piece having a range of 10-20%.

In another aspect, the storage in the refrigerated environment has a duration in a range of up to one year.

In a further aspect of the invention, the refrigerated environment has a temperature range of 0-8° C.

According to anther aspect of the invention, the flavoring includes coating the surfaces of the apple pieces with consumable flavoring that can include natural, cinnamon, caramel, hazelnut, dark chocolate, cappuccino, champagne, peach, strawberry, blueberry, cranberry, banana, vanilla, chocolate, green tea, salt, pepper, garlic, cheese, vinegar, barbecue, pepper, sour cream, onion, or chili.

In a further aspect, the duration between the flavoring and placing the apple pieces in a low-pressure dehydration chamber is in a range of 1-5 hours.

In another aspect, the low-pressure dehydration chamber has a pressure range of 0.2-0.08 kPa.

In yet another aspect, the second state is a dry, popped and crisp state.

In a further aspect of the invention, the second state has a moisture level having a range of 5-1%.

In yet another aspect, the apple pieces are immediately packaged upon the transition from the first state to the second state. Here, the duration between the transition to the second state and the packaging is less than 10 minutes. Further, the packaging can be a hermetically sealed and nitrogen filled container.

### BRIEF DESCRIPTION OF THE FIGURES

The objectives and advantages of the present invention will be understood by reading the following detailed description in conjunction with the drawing, in which:

FIG. 1 shows a flow diagram of the process steps for providing puffed fruit pieces according to the present invention.

FIG. 2 shows a flow diagram of the process steps for providing puffed apple chips according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

To address the need for a delicious, crispy and preservative-free fruit pieces, the current invention is a method of producing puffed fruit pieces made from fresh fruit. The invention includes assessing a fruit variety according to current ambient climate, time of year, surface area, skin thickness, moisture content and size then, a two-part drying process is used, where the fruit pieces are oven baked and then popped. The crispy apple chips can be unflavored or flavored using flavorings such as natural, cinnamon, caramel, hazelnut, dark chocolate, cappuccino, champagne, peach, strawberry, blueberry, cranberry, banana, vanilla, chocolate, green tea, salt, pepper, garlic, cheese, vinegar, barbecue, pepper, sour cream, onion, or chili for example. From the novel infusion-free and reduced step process the apple pieces contain nutrients of their fresh fruit essence, making them a healthful and desirable snack.

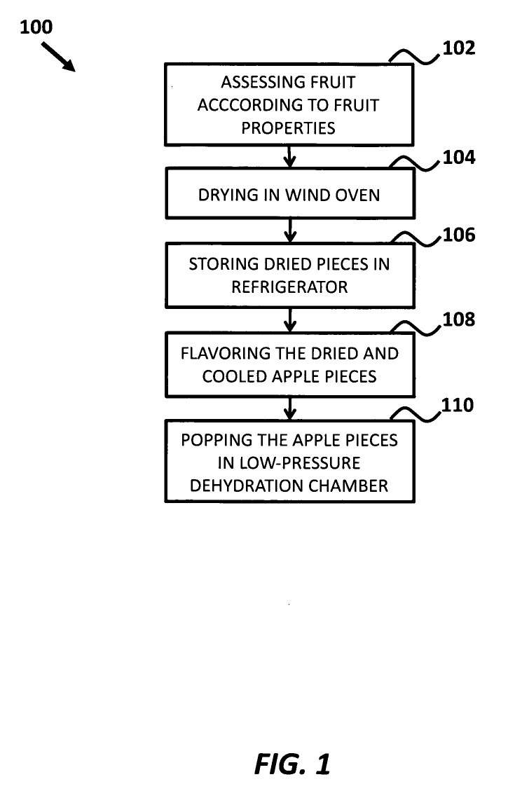

Referring to the figures, FIG. 1 shows a flow diagram of the steps for processing fresh fruit pieces 100 into puffed and crispy fruit pieces, where there is no need for a preservative-infusion step to prevent browning by oxidation. According to FIG. 1, steps include assessing a fruit variety according to current ambient climate, time of year, surface area, skin thickness, moisture content 102 and size drying fruit pieces in a wind oven 104 until a specified moisture-content of the fruit pieces is reached, then storing the fruit pieces in a refrigerated environment 104. The chilled fruit pieces are then flavored 106, and then dehydrated in a low-pressure dehydration chamber 108 until the fruit pieces change from a first state to a second state. The popped and crispy fruit pieces are then immediately packaged in a hermetically sealed container for distribution.

According to the invention, the wind oven is operated in a temperature range from 60-70° C., and operated for a time period having a range from 1-8 hours. The specified moisture is a water content expressed in terms of the mass of water per unit mass of a moist the fruit piece having a range of 10-20%, and the storage in the refrigerated environment has a duration in a range of up to one year, where the refrigerated environment has a temperature range of 0-8° C. The flavoring includes coating the surfaces of the fruit pieces with consumable flavoring that can include natural, cinnamon, caramel, hazelnut, dark chocolate, cappuccino, champagne, peach, strawberry, blueberry, cranberry, banana, vanilla, chocolate, green tea, salt, pepper, garlic, cheese, vinegar, barbecue, pepper, sour cream, onion, or chili. Here, the duration between the flavoring and placing the fruit pieces in a low-pressure dehydration chamber is in a range of 30 min-5 hours, where the low-pressure dehydration chamber has a pressure range of 0.2-0.08 kPa.

One key aspect of the reduced-step process is the wind oven, where it is understood that the wind oven is a sealed oven with an internal fan that circulates the oven heat. In one example, the fan is about a 2.4 kilo Watt fan that operates at about 2900 rpm disposed in a 22 m³ oven. The invention overcomes the need for infusing the fruit pieces with an “anti-browning” preservative by processing the fresh fruit pieces immediately in the wind oven, where the moisture content is reduced before browning can occur.

In yet another aspect, the second state is a dry, popped and crisp state, where the second state has a moisture level having a range of 5-1%. The fruit pieces are immediately packaged upon the transition from the first state to the second state. Here, the duration between the transition to the second state and the packaging is less than 10 minutes. Further, the packaging can be a hermetically sealed and nitrogen filled container.

In another aspect of the invention, the fruit pieces can include apples, blueberries, strawberries, raspberries, blackberries, oranges, kiwis, peaches, apricots, mangos, bananas, pineapple, pears, goji berries, grapes, raisins, Chilean Myrtle fruit, cherries, tomatoes, lychees, cranberries, papayas or acai berries.

To address the need for a delicious, crispy and preservative-free apple chip, the current invention is a method of producing puffed apple chips made from USDA certified organic apples. The invention is a two-part drying process, where the apples are oven baked and then popped. The crispy apple chips can be unflavored or flavored using flavorings such as apple cinnamon, caramel, peach, green tea and chili, for example. From the novel infusion-free and reduced step process the apple pieces contain nutrients of their fresh fruit essence, making them a healthful and desirable snack.

The invention includes providing at least one peeled and cored apple, where the apple is sliced into rings. The apple rings are then dried to a specified moisture-content in a wind oven and sliced into apple pieces, where the apple pieces are stored in a refrigerated environment. The next step is flavoring the refrigerated apple pieces immediately before placing the apple pieces in a low-pressure dehydration chamber, where the flavored refrigerated apple pieces are in a first state, and the apple pieces transition from the first state to a second “popped” state when exposed to the low-pressure. The popped apple pieces are then packaged immediately upon the transition from the first state to the second state. It is because of this reduced-step process that the need for infusing the apple pieces with a preservative to prevent browning and extend the shelf life is eliminated.

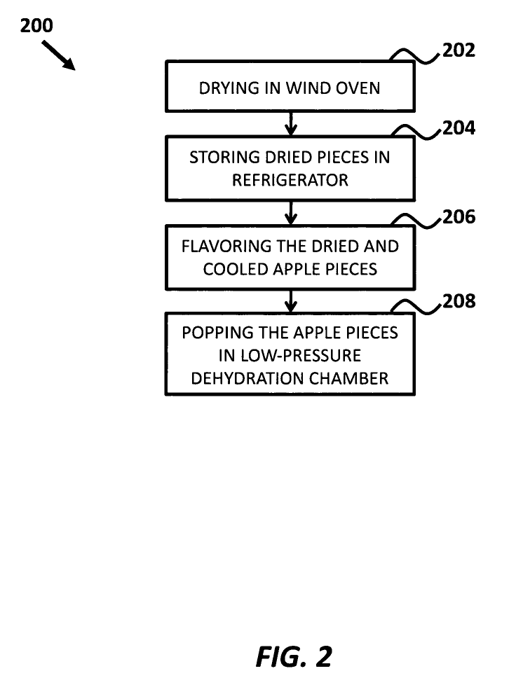

FIG. 2 shows a flow diagram of the steps for processing fresh apples 200 into puffed and crispy apple chips, where there is no need for a preservative-infusion step to prevent browning by oxidation. According to FIG. 2, steps include drying apple pieces in a wind oven 202 until a specified moisture-content of the apple pieces is reached, then storing the apple pieces in a refrigerated environment 204. The chilled apple pieces are then flavored 206, and then dehydrated in a low-pressure dehydration chamber 208 until the apple pieces change from a first state to a second state. The popped and crispy apple pieces are then immediately packaged in a hermetically sealed container for distribution.

One key aspect of the reduced-step process is the wind oven, where it is understood that the wind oven is a sealed oven with an internal fan that circulates the oven heat. In one example, the fan is about a 2.4 kilo Watt fan that operates at about 2900 rpm disposed in a 22 m³ oven. One preferred operating temperature is in the range from 60-70° C. According to one aspect, the wind oven is operated for a time period having a range from 4-8 hours. The invention overcomes the need for infusing the apple pieces with an “anti-browning” preservative by processing the freshly cored, peeled and sliced apple pieces immediately in the wind oven, where the moisture content is reduced before browning can occur.

According to this invention, the specified moisture is defined by a water content expressed in terms of the mass of water per unit mass of a moist said apple piece having a range of 10-20%, and according to the preferred embodiment, a 15% moisture is used. In another aspect of the preferred embodiment the storage in the refrigerated environment is as long as it takes for the apple pieces to reach a temperature of 0° C.-8° C., however it can be up to 1-year, where refrigerated environment has a temperature range of 0° C.-8° C.

The flavoring includes coating the surfaces of the apple pieces with consumable flavoring, such as natural, cinnamon, caramel, hazelnut, dark chocolate, cappuccino, champagne, peach, strawberry, blueberry, cranberry, banana, vanilla, chocolate, green tea, salt, pepper, garlic, cheese, vinegar, barbecue, pepper, sour cream, onion, or chili. It is understood in this document that natural flavoring is leaving the apple pieces uncoated with a flavoring.

Another key aspect of the invention is processing time between the flavoring and popping steps of the apple chips, where the duration between flavoring step and placing the apple pieces in a low-pressure dehydration chamber is in a range of 1-5 hours, or until the second state is a attained that includes a dry, popped and crisp state. The low-pressure dehydration chamber has a pressure range of 0.2-0.08 kPa, however according to a preferred embodiment the pressure is 0.094 kPa. The second state can have a moisture level in the range of 5-1%, however according to a preferred embodiment, a 3% moisture level is used.

Finally, the apple pieces are immediately packaged in a hermetically sealed and nitrogen filled container upon the transition from the first state to the second state, where the duration between the state to state transition is a maximum 10 minutes.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. Popped fruit obtained by the process of:
a. assessing a fruit variety according to current ambient climate, time of year, surface area, skin thickness, moisture content and size;
b. drying pieces of said fruit in a wind oven until a specified moisture content of said fruit pieces are reached;
c. storing said fruit pieces in a refrigerated environment;
d. flavoring said refrigerated fruit pieces;
e. dehydrating said fruit pieces in a low-pressure dehydration chamber until said fruit pieces change from a first state to a second state.

2. The popped fruit pieces obtained by the process of claim 1, wherein said wind oven has an air-speed up to 15 meters per second.

3. The popped fruit pieces obtained by the process of claim 1, wherein said wind oven is operated in a temperature range from 60-70° C.

4. The popped fruit pieces obtained by the process of claim 1, wherein said wind oven is operated for a time period having a range from 1-8 hours.

5. The popped fruit pieces obtained by the process of claim 1, wherein said specified moisture is a water content expressed in terms of the mass of water per unit mass of a moist said fruit piece having a range of 10-20%.

6. The popped fruit pieces obtained by the process of claim 1, wherein said storage in said refrigerated environment has a duration in a range of up to one year.

7. The popped fruit pieces obtained by the process of claim 1, wherein said refrigerated environment has a temperature range of 0-8° C.

8. The popped fruit pieces obtained by the process of claim 1, wherein said flavoring comprises coating the surfaces of said fruit pieces with consumable flavoring, wherein said consumable flavoring is selected from a group consisting of natural, cinnamon, caramel, hazelnut, dark chocolate, cappuccino, champagne, peach, strawberry, blueberry, cranberry, banana, vanilla, chocolate, green tea, salt, pepper, garlic, cheese, vinegar, barbecue, pepper, sour cream, onion, or chili.

9. The popped fruit pieces obtained by the process of claim 1, wherein a duration between said flavoring and placing said fruit pieces in said low-pressure dehydration chamber is in a range of 30 min.-5 hours.

10. The popped fruit pieces obtained by the process of claim 1, wherein said low-pressure dehydration chamber has a pressure range of 0.2-0.08 kPa.

11. The popped fruit pieces obtained by the process of claim 1, wherein said second state is a dry, popped and crisp state.

12. The popped fruit pieces obtained by the process of claim 1, wherein said second state has a moisture level having a range of 5-1%.

13. The popped fruit pieces obtained by the process of claim 1, wherein said fruit pieces are immediately packaged upon said transition from said first state to said second state.

14. The popped fruit pieces obtained by the process of claim 13, wherein a duration between said transition to said second state and said packaging is less than 10 minutes.

15. The popped fruit pieces obtained by the process of claim 13, wherein said packaging comprises a hermetically sealed and nitrogen filled container.

16. The popped fruit pieces obtained by the process of claim 1, wherein said fruit pieces are selected from the group consisting of apples, blueberries, strawberries, raspberries, blackberries, oranges, kiwis, peaches, apricots, mangos, bananas, pineapple, pears, goji berries, grapes, raisins, Chilean Myrtle fruit, cherries, tomatoes, lychees, cranberries, papayas or acai berries.

17. Popped apple pieces obtained by the process of:
a. drying said apple pieces in a wind oven until a specified moisture content of said apple pieces is reached;
b. storing said apple pieces in a refrigerated environment;
c. flavoring said refrigerated apple pieces; and
d. dehydrating said apple pieces in a low-pressure dehydration chamber until said apple pieces change from a first state to a second state.

18. The apple pieces obtained by the process of claim 1, wherein said wind oven has an air-speed up to 15 meters per second

19. The apple pieces obtained by the process of claim 1, wherein said wind oven is operated in a temperature range from 60-70° C.

20. The apple pieces obtained by the process of claim 1, wherein said wind oven is operated for a time period having a range from 1-8 hours.

21. The apple pieces obtained by the process of claim 1, wherein said specified moisture is a water content expressed in terms of the mass of water per unit mass of a moist said apple piece having a range of 10-20%.

22. The apple pieces obtained by the process of claim 1, wherein said storage in said refrigerated environment has a duration in a range of up to one year.

23. The apple pieces obtained by the process of claim 1, wherein said refrigerated environment has a temperature range of 0-8° C.

24. The apple pieces obtained by the process of claim 1, wherein said flavoring comprises coating the surfaces of said apple pieces with consumable flavoring, wherein said consumable flavoring is selected from a group consisting of natural, cinnamon, caramel, hazelnut, dark chocolate, cappuccino, champagne, peach, strawberry, blueberry, cranberry, banana, vanilla, chocolate, green tea, salt, pepper, garlic, cheese, vinegar, barbecue, pepper, sour cream, onion, or chili.

25. The apple pieces obtained by the process of claim 1, wherein a duration between said flavoring and placing said apple pieces in a low-pressure dehydration chamber is in a range of 30 min.-5 hours.

26. The apple pieces obtained by the process of claim 1, wherein said low-pressure dehydration chamber has a pressure range of 0.2-0.08 kPa.

27. The apple pieces obtained by the process of claim 1, wherein said second state is a dry, popped and crisp state.

28. The apple pieces obtained by the process of claim 1, wherein said second state has a moisture level having a range of 5-1%.

29. The apple pieces obtained by the process of claim 1, wherein said apple pieces are immediately packaged upon said transition from said first state to said second state.

30. The apple pieces obtained by the process of claim 29, wherein a duration between said transition to said second state and said packaging is less than 10 minutes.

31. The apple pieces obtained by the process of claim 29, wherein said packaging comprises a hermetically sealed and nitrogen filled container.
